(19) United States
(12) Patent Application Publication
(10) Pub. No.: US 2026/0103623 A1
(43) Pub. Date: Apr. 16, 2026

(54) TWO-PART, CYANOACRYLATE/FREE RADICALLY CURABLE ADHESIVE SYSTEMS

(71) Applicant: Henkel AG & Co. KGaA, Düsseldorf (DE)

(72) Inventors: Jesse L. Davis, Hartford, CT (US); Chetan Hire, Glastonbury, CT (US); Shabbir T. Attarwala, Simsbury, CT (US)

(21) Appl. No.: 19/420,969

(22) Filed: Dec. 16, 2025

Related U.S. Application Data
(63) Continuation of application No. 17/709,810, filed on Mar. 31, 2022.
Application No. 17/709,810 is a continuation of application No. PCT/US2020/053774, filed on Oct. 1, 2020.
(60) Provisional application No. 62/908,871, filed on Oct. 1, 2019.

(51) Int. Cl. C09J 4/06; C08F 222/32; C08K 5/14; C08L 9/06; C08L 33/12; C09J 151/04

(52) U.S. Cl. CPC C09J 4/06; C08F 222/322; C08K 5/14; C08L 9/06; C08L 33/12; C09J 151/04; C08L 2207/53; C09J 2451/00

(57) ABSTRACT

Two-part cyanoacrylate/free radically curable adhesive systems demonstrating improved impact toughness performance are provided.

### BACKGROUND

### Field

Two-part cyanoacrylate/free radically curable adhesive systems demonstrating improved impact toughness performance are provided.

### Brief Discussion of Related Technology

Curable compositions such as cyanoacrylate adhesives are well recognized for their excellent ability to rapidly bond a wide range of substrates, generally in a number of minutes and depending on the particular substrate, often in a number of seconds.

Polymerization of cyanoacrylates is initiated by nucleophiles found under normal atmospheric conditions on most surfaces. The initiation by surface chemistry means that sufficient initiating species are available when two surfaces are in close contact with a small layer of cyanoacrylate between the two surfaces. Under these conditions a strong bond is obtained in a short period of time. Thus, in essence the cyanoacrylate often functions as an instant adhesive.

Cyanoacrylate adhesive performance, particularly durability, oftentimes becomes suspect when exposed to elevated temperature conditions and/or high relative humidity conditions. To combat these application-dependent shortcomings, a host of additives have been identified for inclusion in cyanoacrylate adhesive formulations. Improvements would still be seen as beneficial.

A variety of additives and fillers have been added to cyanoacrylate compositions to modify physical properties.

For instance, U.S. Pat. No. 3,183,217 to Serniuk et al. discloses free radical polymerization of a methacrylic acid or methyl methacrylate monomer with a non-polar or mildly polar olefin where the monomer is complexed with a Friedel-Crafts halide.

U.S. Pat. No. 3,963,772 to Takeshita discloses liquid telomers of alkylene and acrylic monomers which result in short chain alternating copolymers substantially terminated at one end of the polymer chains with the more reactive alkylene units. The liquid telomers are useful in making elastomeric polymers for high molecular weight rubbers which permit the ready incorporation of fillers, additives, and the like, due to its liquid phase.

U.S. Pat. No. 4,440,910 to O'Connor is directed to cyanoacrylate compositions having improved toughness, achieved through the addition of elastomers, i.e., acrylic rubbers. These rubbers are either (i) homopolymers of alkyl esters of acrylic acid; (ii) copolymers of another polymerizable monomer, such as lower alkenes, with an alkyl ester of acrylic acid or with an alkoxy ester of acrylic acid; (iii) copolymers of alkyl esters of acrylic acid; (iv) copolymers of alkoxy esters of acrylic acid; and (v) mixtures thereof.

U.S. Pat. No. 4,560,723 to Millet et al. discloses a cyanoacrylate adhesive composition containing a toughening agent comprising a core-shell polymer and a sustainer comprising an organic compound containing one or more unsubstituted or substituted aryl groups. The sustainer is reported to improve retention of toughness after heat aging of cured bonds of the adhesive. The core-shell polymer is treated with an acid wash to remove any polymerization-causing impurities such as salts, soaps or other nucleophilic species left over from the core-shell polymer manufacturing process.

U.S. Pat. No. 5,340,873 to Mitry discloses a cyanoacrylate adhesive composition having improved toughness by including an effective toughening amount of a polyester polymer derived from a dibasic aliphatic or aromatic carboxylic acid and a glycol.

U.S. Pat. No. 5,994,464 to Ohsawa et al. discloses a cyanoacrylate adhesive composition containing a cyanoacrylate monomer, an elastomer miscible or compatible with the cyanoacrylate monomer, and a core-shell polymer being compatible, but not miscible, with the cyanoacrylate monomer.

U.S. Pat. No. 6,833,196 to Wojciak discloses a method of enhancing the toughness of a cyanoacrylate composition between steel and EPDM rubber substrates. The disclosed method is defined by the steps of: providing a cyanoacrylate component; and providing a toughening agent comprising methyl methacrylic monomer and at least one of butyl acrylic monomer and isobornyl acrylic monomer, whereby the acrylic monomer toughening agent enhances the toughness of the cyanoacrylate composition such that whereupon cure, the cyanoacrylate composition has an average tensile shear strength of over about 4400 psi after 72 hours at room temperature cure and 2 hours post cure at 121° C.

Reactive acrylic adhesives that cure by free radical polymerization of (meth)acrylic esters (i.e., acrylates) are known, but suffer from certain drawbacks. Commercially important acrylic adhesives tend to have an offensive odor, particularly those that are made from methyl methacrylate. Methyl methacrylate-based acrylic adhesives also have low flash points (approximately 59° F.). Low flash points are particularly an issue during storage and transportation of the adhesives. If the flash point is 141° F. or lower, the U.S. Department of Transportation classifies the product as “Flammable” and requires marking and special storage and transportation conditions.

U.S. Pat. No. 6,562,181 to Righettini intends to provide a solution to the problem addressed in the preceding paragraph by describing an adhesive composition comprising: (a) a trifunctional olefinic first monomer comprising an olefinic group that has at least three functional groups each bonded directly to the unsaturated carbon atoms of said olefinic group; (b) an olefinic second monomer that is copolymerizable with the first monomer; (c) a redox initiator system, and (d) a reactive diluent, where the composition is a liquid at room temperature is 100% reactive and substantially free of volatile organic solvent, and is curable at room temperature.

And more recently, U.S. Pat. No. 9,371,470 to Burns describes and claims a two-part curable composition comprising:
(a) a first part comprising a cyanoacrylate component and a peroxide catalyst; and (b) a second part comprising a free radical curable component and a transition metal. When mixed together the peroxide catalyst initiates cure of the free radical curable component and the transition metal initiates cure of the cyanoacrylate component. In a particular embodiment, the peroxide catalyst is t-butyl perbenzoate.

In unrelated technology, U.S. Pat. No. 9,068,036 (Navarro) is directed to and claims a thermoplastic polymer composition comprising a) one thermoplastic polymer, and b) a core-shell impact modifier obtained by a process comprising the steps of: i) synthesizing a core-shell copolymer latex by emulsion polymerization; ii) controlling and adjusting of pH value of the core shell polymer particle after the synthesis step; iii) coagulation of the core shell polymer at a pH between 4 and 8 by addition of an aqueous electrolyte solution, whereby the resulting core-shell impact modifier comprises a polymeric core and at least two polymeric layers surrounding the core, each layer having a different polymer composition from the other layer and, wherein at least one polymeric layer comprises a polymer that is a gradient polymer, the gradient polymer being a copolymer consisting of at least two different monomers (A) and (B) and having a gradient in repeat units arranged from mostly the monomer (A) to mostly the monomer (B) along the copolymer.

U.S. Pat. No. 9,714,314 (Navarro) is directed to and claims a core-shell copolymer impact modifier particle having a particle size between 170 and 350 nm and a pH between 6 and 7.5 comprising one polymeric rubber core comprising at least partially crosslinked isoprene or butadiene and optionally styrene, and at least two polymeric layers wherein at least one polymeric layer is an outermost thermoplastic shell layer having a Tg greater than 25° C., each layer having a different polymer composition, wherein at least one layer is a gradient zone produced in a polymerization stage reaction in which mostly a first monomer of styrene is incorporated during an initial stage of polymerization while increasing the amount of methyl methacrylate second monomer until mostly or entirely methyl methacrylate is incorporated during polymerization of a final stage, forming the gradient zone, and wherein the glass transition temperature of the polymeric core is under 0° C.

Notwithstanding the state of the art, it would be desirable to provide an adhesive system having both the features of an instant adhesive, such as in terms of the fast fixture times and ability to bond a wide range of substrates such as metals and plastics observed with cyanoacrylates, together with the improved bond strength over a greater variety and/or selection of substrates seen with (meth)acrylate compositions. In addition, it would be desirable for the two-part reactive adhesive to be toughened so that reaction products thereof can withstand exposure to a variety of extreme conditions without sacrificing useful bond strength.

### SUMMARY

There is provided in one aspect a two-part cyanoacrylate/free radically curable composition comprising:
(a) a first part comprising a cyanoacrylate component and a peroxide catalyst; and
(b) a second part comprising a free radical curable component and a transition metal.

When mixed together, the peroxide catalyst of the first part initiates cure of the free radically curable component of the second part and the transition metal of the second part initiates cure of the cyanoacrylate of the first part.

Significantly, in at least one of the first part or the second part is further provided a core-shell impact modifier comprises a polymeric core and at least two polymeric layers surrounding the core, each layer having a different polymer composition from the other layer and, wherein at least one polymeric layer comprises a polymer that is a gradient polymer, the gradient polymer being a copolymer consisting of at least two different monomers (A) and (B) and having a gradient in repeat units arranged from mostly the monomer (A) to mostly the monomer (B) along the copolymer.

The compositions, which are room temperature curable as the first part and the second part do not interact prior to use on mixing, provide good performance across substrates constructed from a wide variety of materials and provide improved impact toughness performance over two part cyanoacrylate/free radically curable composition having conventional core shell rubbers.

### BRIEF DESCRIPTION OF THE FIGURE

FIG. 1 depicts a bar chart of various adhesive systems used to bond metal (i.e., grit blasted mild steel and aluminum) substrates shown on the X axis and impact toughness performance measured at 0 gap and 1 mm gap in Joules shown on the Y axis.

### DETAILED DESCRIPTION

### Part A

The cyanoacrylate component includes cyanoacrylate monomers, such as those represented by H₂C═C(CN)—COOR, where R is selected from C₁₋₁₅ alkyl, C₂₋₁₅ alkoxyalkyl, C₃₋₁₅ cycloalkyl, C₂₋₁₅ alkenyl, C₇₋₁₅ aralkyl, C₆₋₁₅ aryl, C₃₋₁₅ allyl and C₁₋₁₅ haloalkyl groups. Desirably, the cyanoacrylate monomer is selected from methyl cyanoacrylate, ethyl-2-cyanoacrylate (“ECA”), propyl cyanoacrylates, butyl cyanoacrylates (such as n-butyl-2-cyanoacrylate), octyl cyanoacrylates, allyl cyanoacrylate, β-methoxyethyl cyanoacrylate and combinations thereof. A particularly desirable one is ethyl-2-cyanoacrylate.

The cyanoacrylate component should be included in the Part A composition in an amount within the range of from about 50 weight percent to about 99.98 weight percent, such as about 90 weight percent to about 99 weight percent being desirable, and about 92 weight percent to about 97 weight percent of the Part A composition being particularly desirable.

As the peroxide catalyst to be included in the Part A composition of the two-part adhesive system, perbenzoates should be used, such as t-butylperbenzoate.

Typically, the amount of peroxide catalyst should fall in the range of about 0.001 weight percent up to about 10.00 weight percent of the composition, desirably about 0.01 weight percent up to about 5.00 weight percent of the composition, such as about 0.50 to 2.50 weight percent of the composition.

Additives may be included in the Part A composition of the adhesive system to modify physical properties, such as improved fixture speed, improved shelf-life stability, flexibility, thixotropy, increased viscosity, color, and improved toughness. Such additives therefore may be selected from accelerators, free radical stabilizers, anionic stabilizers, gelling agents, thickeners [such as PMMAs], thixotropy conferring agents (such as fumed silica), dyes, toughening agents, plasticizers and combinations thereof.

One or more accelerators may also be used in the adhesive system, particularly, in the Part A composition, to accelerate cure of the cyanoacrylate component. Such accelerators may be selected from calixarenes and oxacalixarenes, silacrowns, crown ethers, cyclodextrins, poly(ethyleneglycol) di(meth)acrylates, ethoxylated hydric compounds and combinations thereof.

Of the calixarenes and oxacalixarenes, many are known, and are reported in the patent literature. See e.g. U.S. Pat. Nos. 4,556,700, 4,622,414, 4,636,539, 4,695,615, 4,718,966, and 4,855,461, the disclosures of each of which are hereby expressly incorporated herein by reference.

For instance, as regards calixarenes, those within the structure below are useful herein:

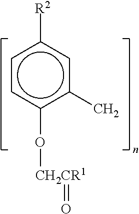

where R¹ is alkyl, alkoxy, substituted alkyl or substituted alkoxy; R² is H or alkyl; and n is 4, 6 or 8.

One particularly desirable calixarene is tetrabutyl tetra [2-ethoxy-2-oxoethoxy]calix-4-arene.

A host of crown ethers are known. For instance, examples which may be used herein either individually or in combination include 15-crown-5, 18-crown-6, dibenzo-18-crown-6, benzo-15-crown-5-dibenzo-24-crown-8, dibenzo-30-crown-10, tribenzo-18-crown-6, asym-dibenzo-22-crown-6, dibenzo-14-crown-4, dicyclohexyl-18-crown-6, dicyclohexyl-24-crown-8, cyclohexyl-12-crown-4, 1,2-decalyl-15-crown-5, 1,2-naphtho-15-crown-5, 3,4,5-naphtyl-16-crown-5, 1,2-methyl-benzo-18-crown-6, 1,2-methylbenzo-5, 6-methylbenzo-18-crown-6, 1,2-t-butyl-18-crown-6, 1,2-vinylbenzo-15-crown-5, 1,2-vinylbenzo-18-crown-6, 1,2-t-butyl-cyclohexyl-18-crown-6, asym-dibenzo-22-crown-6 and 1,2-benzo-1,4-benzo-5-oxygen-20-crown-7. See U.S. Pat. No. 4,837,260 (Sato), the disclosure of which is hereby expressly incorporated here by reference.

Of the silacrowns, again many are known, and are reported in the literature. For instance, a typical silacrown may be represented within the structure below:

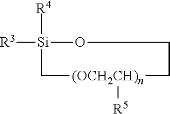

where R³ and R⁴ are organo groups which do not themselves cause polymerization of the cyanoacrylate monomer, R⁵ is H or CH₃ and n is an integer of between 1 and 4. Examples of suitable R³ and R⁴ groups are R groups, alkoxy groups, such as methoxy, and aryloxy groups, such as phenoxy. The R³ and R⁴ groups may contain halogen or other substituents, an example being trifluoropropyl. However, groups not suitable as R⁴ and R⁵ groups are basic groups, such as amino, substituted amino and alkylamino.

Specific examples of silacrown compounds useful in the inventive compositions include:

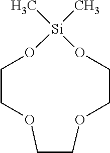

dimethylsila-11-crown-4;

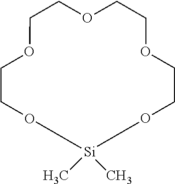 [SMILES: C[Si]1(C)OCCOCCOCCOCCO1]

dimethylsila-14-crown-5;

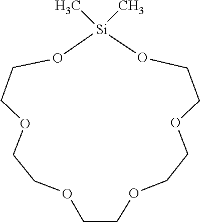 [SMILES: C[Si]1(C)OCCOCCOCCOCCOCCO1]

and dimethylsila-17-crown-6. See e.g. U.S. Pat. No. 4,906,317 (Liu), the disclosure of which is hereby expressly incorporated herein by reference.

Many cyclodextrins may be used in connection with the present invention. For instance, those described and claimed in U.S. Pat. No. 5,312,864 (Wenz), the disclosure of which is hereby expressly incorporated herein by reference, as hydroxyl group derivatives of an a, B or DB-cyclodextrin which is at least partly soluble in the cyanoacrylate would be appropriate choices for use herein as an accelerator component.

In addition, poly(ethylene glycol) di(meth)acrylates suitable for use herein include those within the structure below:

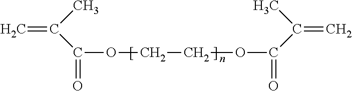

where n is greater than 3, such as within the range of 3 to 12, with n being 9 as particularly desirable. More specific examples include PEG 200 DMA (where n is about 4), PEG 400 DMA (where n is about 9), PEG 600 DMA (where n is about 14), and PEG 800 DMA (where n is about 19), where the number (e.g. 400) represents the average molecular weight of the glycol portion of the molecule, excluding the two methacrylate groups, expressed as grams/mole (i.e., 400 g/mol). A particularly desirable PEG DMA is PEG 400 DMA.

And of the ethoxylated hydric compounds (or ethoxylated fatty alcohols that may be employed), appropriate ones may be chosen from those within the structure below:

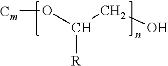

where Cₘ can be a linear or branched alkyl or alkenyl chain, m is an integer between 1 to 30, such as from 5 to 20, n is an integer between 2 to 30, such as from 5 to 15, and R may be H or alkyl, such as C₁₋₆ alkyl.

In addition, accelerators embraced within the structure below:

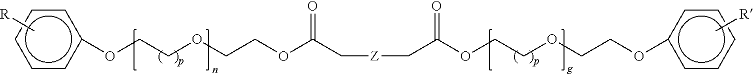

where R is hydrogen, C₁₋₆ alkyl, C₁₋₆ alkyloxy, alkyl thioethers, haloalkyl, carboxylic acid and esters thereof, sulfinic, sulfonic and sulfurous acids and esters, phosphinic, phosphonic and phosphorous acids and esters thereof, Z is a polyether linkage, n is 1-12 and p is 1-3 are as defined above, and R′ is the same as R, and g is the same as n.

A particularly desirable chemical within this class as an accelerator component is

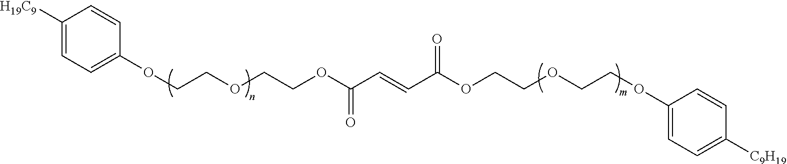

where n and m combined are greater than or equal to 12.

The accelerator should be included in the composition in an amount within the range of from about 0.01 weight percent to about 10 weight percent, with the range of about 0.1 to about 0.5 weight percent being desirable, and about 0.4 weight percent of the total composition being particularly desirable.

Stabilizers useful in the Part A composition of the adhesive system include free-radical stabilizers, anionic stabilizers and stabilizer packages that include combinations thereof. The identity and amount of such stabilizers are well known to those of ordinary skill in the art. See e.g. U.S. Pat. Nos. 5,530,037 and 6,607,632, the disclosures of each of which are hereby incorporated herein by reference. Commonly used free-radical stabilizers include hydroquinone, while commonly used anionic stabilizers include boron triflouride, boron trifluoride-etherate, sulphur trioxide (and hydrolyis products thereof) and methane sulfonic acid.

### Part B

Free radical curable monomers for use in the Part B composition of the adhesive system include (meth)acrylate monomers, maleimide-, itaconamide- or nadimide-containing compounds and combinations thereof.

(Meth)acrylate monomers for use in Part B of the composition of the adhesive system include a host of (meth)acrylate monomers, with some of the (meth)acrylate monomers being aromatic, while others are aliphatic and still others are cycloaliphatic. Examples of such (meth)acrylate monomers include di- or tri-functional (meth)acrylates like polyethylene glycol di(meth)acrylates, tetrahydrofuran (meth)acrylates and di(meth)acrylates, hydroxypropyl (meth)acrylate (“HPMA”), hexanediol di(meth)acrylate, trimethylol propane tri(meth)acrylate (“TMPTMA”), diethylene glycol dimethacrylate, triethylene glycol dimethacrylate (“TRIEGMA”), benzylmethacrylate, tetraethylene glycol dimethacrylate, dipropylene glycol dimethacrylate, di-(pentamethylene glycol) dimethacrylate, tetraethylene diglycol diacrylate, diglycerol tetramethacrylate, tetramethylene dimethacrylate, ethylene dimethacrylate, neopentyl glycol diacrylate, trimethylol propane triacrylate and bisphenol-A mono and di(meth)acrylates, such as ethoxylated bisphenol-A (meth)acrylate (“EBIPMA”), bisphenol-F mono and di(meth)acrylates, such as ethoxylated bisphenol-F (meth)acrylate, and (meth)acrylate-functionalized urethanes.

For instance, examples of such (meth)acrylate-functionalized urethanes include a tetramethylene glycol urethane acrylate oligomer and a propylene glycol urethane acrylate oligomer.

Other (meth)acrylate-functionalized urethanes are urethane (meth)acrylate oligomers based on polyethers or polyesters, which are reacted with aromatic, aliphatic, or cycloaliphatic diisocyanates and capped with hydroxy acrylates. For instance, difunctional urethane acrylate oligomers, such as a polyester of hexanedioic acid and diethylene glycol, terminated with isophorone diisocyanate, capped with 2-hydroxyethyl acrylate (CAS 72121-94-9); a polypropylene glycol terminated with tolyene-2,6-diisocyanate, capped with 2-hydroxyethylacrylate (CAS 37302-70-8); a polyester of hexanedioic acid and diethylene glycol, terminated with 4,4′-methylenebis(cyclohexyl isocyanate), capped with 2-hydroxyethyl acrylate (CAS 69011-33-2); a polyester of hexanedioic acid, 1,2-ethanediol, and 1,2 propanediol, terminated with tolylene-2,4-diisocyanate, capped with 2-hydroxyethyl acrylate (CAS 69011-31-0); a polyester of hexanedioic acid, 1,2-ethanediol, and 1,2 propanediol, terminated with 4,4′-methylenebis(cyclohexyl isocyanate, capped with 2-hydroxyethyl acrylate (CAS 69011-32-1); and a polytetramethylene glycol ether terminated with 4,4′-methylenebis(cyclohexylisocyanate), capped with 2-hydroxyethyl acrylate.

Still other (meth)acrylate-functionalized urethanes are monofunctional urethane acrylate oligomers, such as a polypropylene terminated with 4,4′-methylenebis(cyclohexylisocyanate), capped with 2-hydroxyethyl acrylate and 1-dodosanol.

They also include difunctional urethane methacrylate oligomers such as a polytetramethylene glycol ether terminated with tolulene-2,4-diisocyanate, capped with 2-hydroxyethyl methacrylate; a polytetramethylene glycol ether terminated with isophorone diisocyanate, capped with 2-hydroxyethyl methacrylate; a polytetramethylene glycol ether terminated with 4,4′-methylenebis(cyclohexylisocyanate), capped with 2-hydroxyethyl methacrylate; and a polypropylene glycol terminated with tolylene-2,4-diisocyanate, capped with 2-hydroxyethyl methacrylate.

The maleimides, nadimides, and itaconimides include those compounds having the following structures I, II and III, respectively

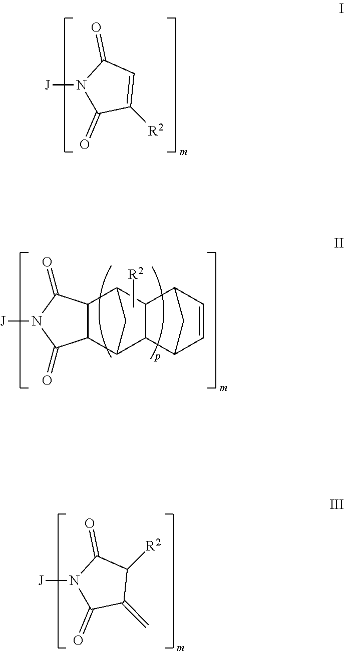

where:

$$m = 1 - 15 ,$$

$$p = 0 - 15 ,$$

each R² is independently selected from hydrogen or lower alkyl, and
J is a monovalent or a polyvalent moiety comprising organic or organosiloxane radicals, and combinations of two or more thereof.

More specific representations of the maleimides, itaconimides and nadimides include those corresponding to structures I, II, or III, where m=1-6, p=0, R² is independently selected from hydrogen or lower alkyl, and J is a monovalent or polyvalent radical selected from hydrocarbyl, substituted hydrocarbyl, heteroatom-containing hydrocarbyl, substituted heteroatom-containing hydrocarbyl, hydrocarbylene, substituted hydrocarbylene, heteroatom-containing hydrocarbylene, substituted heteroatom-containing hydrocarbylene, polysiloxane, polysiloxane-polyurethane block copolymer, and combinations of two or more thereof, optionally containing one or more linkers selected from a covalent bond, —O—, —S—, —NR—, —O—C(O)—, —O—C(O)—O—, —O—C(O)—NR—, —NR—C(O)—, —NR—C(O)—O—, —NR—C(O)—NR—, —S—C(O)—, —S—C(O)—O—, —S—C(O)—NR—, —S(O)—, —S(O)₂—, —O—S(O)₂—, —O—S(O)₂—O—, —O—S(O)₂—NR—, —O—S(O)—, —O—S(O)—O—, —O—S(O)—NR—, —O—NR—C(O)—, —O—NR—C(O)—O—, —O—NR—C(O)—NR—, —NR—O—C(O)—, —NR—O—C(O)—O—, —NR—O—C(O)—NR—, —O—NR—C(S)—, —O—NR—C(S)—O—, —O—NR—C(S)—NR—, —NR—O—C(S)—, —NR—O—C(S)—O—, —NR—O—C(S)—NR—, —O—C(S)—, —O—C(S)—O—, —O—C(S)—NR—, —NR—C(S)—, —NR—C(S)—O—, —NR—C(S)—NR—, —S—S(O)₂—, —S—S(O)₂—O—, —S—S(O)₂—NR—, —NR—O—S(O)—, —NR—O—S(O)—O—, —NR—O—S(O)—NR—, —NR—O—S(O)₂—, —NR—O—S(O)₂—O—, —NR—O—S(O)₂—NR—, —O—NR—S(O)—, —O—NR—S(O)—O—, —O—NR—S(O)—NR—, —O—NR—S(O)₂—O—, —O—NR—S(O)₂—NR—, —O—NR—S(O)₂—, —O—P(O)R²—, —S—P(O)R²—, —NR—P(O)R²—, where each R is independently hydrogen, alkyl or substituted alkyl, and combinations of any two or more thereof.

When one or more of the above described monovalent or polyvalent groups contain one or more of the above described linkers to form the “J” appendage of a maleimide, nadimide or itaconimide group, as readily recognized by those of skill in the art, a wide variety of linkers can be produced, such as, for example, oxyalkyl, thioalkyl, aminoalkyl, carboxylalkyl, oxyalkenyl, thioalkenyl, aminoalkenyl, carboxyalkenyl, oxyalkynyl, thioalkynyl, aminoalkynyl, carboxyalkynyl, oxycycloalkyl, thiocycloalkyl, aminocycloalkyl, carboxycycloalkyl, oxycloalkenyl, thiocycloalkenyl, aminocycloalkenyl, carboxycycloalkenyl, heterocyclic, oxyheterocyclic, thioheterocyclic, aminoheterocyclic, carboxyheterocyclic, oxyaryl, thioaryl, aminoaryl, carboxyaryl, heteroaryl, oxyheteroaryl, thioheteroaryl, aminoheteroaryl, carboxyheteroaryl, oxyalkylaryl, thioalkylaryl, aminoalkylaryl, carboxyalkylaryl, oxyarylalkyl, thioarylalkyl, aminoarylalkyl, carboxyarylalkyl, oxyarylalkenyl, thioarylalkenyl, aminoarylalkenyl, carboxyarylalkenyl, oxyalkenylaryl, thioalkenylaryl, aminoalkenylaryl, carboxyalkenylaryl, oxyarylalkynyl, thioarylalkynyl, aminoarylalkynyl, carboxyarylalkynyl, oxyalkynylaryl, thioalkynylaryl, aminoalkynylaryl or carboxyalkynylaryl, oxyalkylene, thioalkylene, aminoalkylene, carboxyalkylene, oxyalkenylene, thioalkenylene, aminoalkenylene, carboxyalkenylene, oxyalkynylene, thioalkynylene, aminoalkynylene, carboxyalkynylene, oxycycloalkylene, thiocycloalkylene, aminocycloalkylene, carboxycycloalkylene, oxycycloalkenylene, thiocycloalkenyle aminoalkylarylene, carboxyalkylarylene, oxyarylalkylene, thioarylalkylene, aminoarylalkylene, carboxyarylalkylene, oxyarylalkenylene, thioarylalkenylene, aminoarylalkenylene, carboxyarylalkenylene, oxyalkenylarylene, thioalkenylarylene, aminoalkenylarylene, carboxyalkenylarylene, oxyarylalkynylene, thioarylalkynylene, aminoarylalkynylene, carboxy arylalkynylene, oxyalkynylarylene, thioalkynylarylene, aminoalkynylarylene, carboxyalkynylarylene, heteroarylene, oxyheteroarylene, thioheteroarylene, aminoheteroarylene, carboxyheteroarylene, heteroatom-containing di- or polyvalent cyclic moiety, oxyheteroatom-containing di- or polyvalent cyclic moiety, thioheteroatom-containing di- or polyvalent cyclic moiety, aminoheteroatom-containing di- or polyvalent cyclic moiety, carboxyheteroatom-containing di- or polyvalent cyclic moiety, disulfide, sulfonamide, and the like.

In another embodiment, maleimides, nadimides, and itaconimides contemplated for use in the practice of the present invention have the structures I, II, and III, where m=1-6, p=0-6, and J is selected from saturated straight chain alkyl or branched chain alkyl, optionally containing optionally substituted aryl moieties as substituents on the alkyl chain or as part of the backbone of the alkyl chain, and where the alkyl chains have up to about 20 carbon atoms;
a siloxane having the structure: —(C(R³)₂)_{d}—[Si(R⁴)₂—O](—Si(R⁴)₂—(C(R³)₂)ₑ—, —(C(R³)₂)_{d}—C(R³)—C(O)O—(C(R³)₂)ₐ—[Si(R⁴)₂—O]—Si(R⁴)₂—(C(R³)₂)ₑ—O(O)C—(C(R³)₂)ₑ—, or —(C(R³)₂)—C(R³)—O(O)C—(C(R³)₂)ₐ—[Si(R⁴)₂—O]_{f}—Si(R⁴)₂—(C(R³)₂)ₑ—C(O)O—(C(R³)₂)ₑ—, where:
each R³ is independently hydrogen, alkyl or substituted alkyl,
each R⁴ is independently hydrogen, lower alkyl or aryl,
d=1-10,
e=1-10, and
f=1-50;
a polyalkylene oxide having the structure:

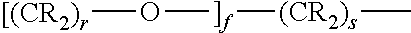

where:
each R is independently hydrogen, alkyl or substituted alkyl,
r=1-10,
s=1-10, and
f is as defined above;
aromatic groups having the structure:

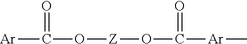

where:
each Ar is a monosubstituted, disubstituted or trisubstituted aromatic or heteroaromatic ring having in the range of 3 up to 10 carbon atoms, and
Z is:
   saturated straight chain alkylene or branched chain alkylene, optionally containing saturated cyclic moieties as substituents on the alkylene chain or as part of the backbone of the alkylene chain, or
   polyalkylene oxides having the structure:

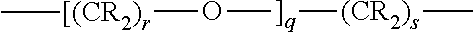

where:
   each R is independently hydrogen, alkyl or substituted alkyl, r and s are each defined as above, and
   q falls in the range of 1 up to 50;
   di- or tri-substituted aromatic moieties having the structure:

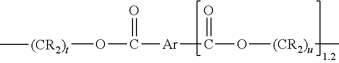

where:
each R is independently hydrogen, alkyl or substituted alkyl,
t falls in the range of 2 up to 10,
u falls in the range of 2 up to 10, and
Ar is as defined above;
aromatic groups having the structure:

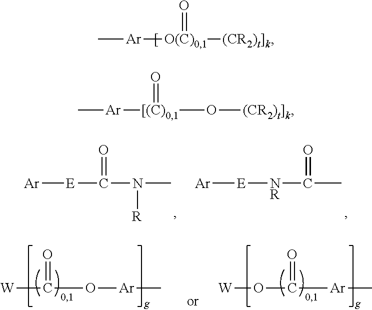

where:
each R is independently hydrogen, alkyl or substituted alkyl,
t=2-10,
k=1, 2 or 3,
g=1 up to about 50,
each Ar is as defined above,
E is —O— or —NR⁵—, where R⁵ is hydrogen or lower alkyl; and
W is straight or branched chain alkyl, alkylene, oxyalkylene, alkenyl, alkenylene, oxyalkenylene, ester, or polyester, a siloxane having the structure —(C(R³)₂)_{d}—[Si(R⁴)₂—O]—Si(R⁴)₂—(C(R³)₂)ₑ—, —(C(R³)₂)_{d}—C(R³)—C(O)O—(C(R³)₂)ₐ—[Si(R⁴)₂—O]_{f}—Si(R⁴)₂—(C(R³)₂)ₑ—O(O)C—(C(R³)₂)ₑ—, or —(C(R³)₂)_{d}—C(R³)—O(O)C—(C(R³)₂)_{d}—[Si(R⁴)₂—O]_{f}—Si(RA)₂—(C(R³)₂)ₑ—C(O)O—(C(R³)₂)ₑ—, where:
   each R³ is independently hydrogen, alkyl or substituted alkyl,
   each R⁴ is independently hydrogen, lower alkyl or aryl,
   d=1-10,
   e=1-10, and
   f=1-50;
   a polyalkylene oxide having the structure:

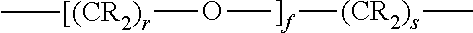

where:
each R is independently hydrogen, alkyl or substituted alkyl,
r=1-10,
s=1-10, and
f is as defined above;
optionally containing substituents selected from hydroxy, alkoxy, carboxy, nitrile, cycloalkyl or cycloalkenyl;
a urethane group having the structure:

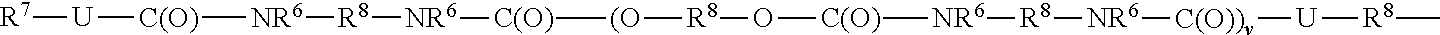

where:
each R⁶ is independently hydrogen or lower alkyl,
each R⁷ is independently an alkyl, aryl, or arylalkyl group having 1 to 18 carbon atoms,
each R⁸ is an alkyl or alkyloxy chain having up to about 100 atoms in the chain, optionally substituted with Ar,
U is —O—, —S—, —N(R)—, or —P(L)_{1,2}-,
   where R as defined above, and where each L is independently ═O, ═S, —OR—R; and
v=0-50;
   polycyclic alkenyl; or mixtures of any two or more thereof.

In a more specific recitation of such maleimide-, nadimide-, and itaconimide-containing compounds of structures I, II and III, respectively, each R is independently hydrogen or lower alkyl (such as (14), -J-comprises a branched chain alkyl, alkylene, alkylene oxide, alkylene carboxyl or alkylene amido species having sufficient length and branching to render the maleimide, nadimide and/or itaconimide compound a liquid, and m is 1, 2 or 3.

Particularly desirable maleimide-containing compounds include those have two maleimide groups with an aromatic group therebetween, such as a phenyl, biphenyl, bisphenyl or napthyl linkage.

In addition to the free radical curable component, Part B also includes a transition metal compound. A non-exhaustive list of representative examples of the transition metal compounds are copper, vanadium, cobalt and iron compounds. For instance, as regards copper compounds, copper compounds where copper enjoys a 1+ or 2+ valence state are desirable. A non-exhaustive list of examples of such copper (I) and (II) compounds include copper (II) 3,5-diisopropylsalicylate hydrate, copper bis(2,2,6,6-tetramethyl-3,5-heptanedionate), copper (II) hydroxide phosphate, copper (II) chloride, copper (II) acetate monohydrate, tetrakis(acetonitrile) copper (I) hexafluorophosphate, copper (II) formate hydrate, tetrakisacetonitrile copper (I) triflate, copper (II) tetrafluoroborate, copper (II) perchlorate, tetrakis(acetonitrile) copper (I) tetrafluoroborate, copper (II) hydroxide, copper (II) hexafluoroacetylacetonate hydrate and copper (II) carbonate. These copper (I) and (II) compounds should be used in an amount such that when dissolved or suspended in a carrier vehicle, such as a (meth)acrylate, a concentration of about 100 ppm to about 5,000 ppm, such as about 500 ppm to about 2,500 ppm, for instance about 1,000 ppm is present in the solution or suspension.

As regards vanadium compounds, vanadium compounds where vanadium enjoys a 2+ and 3+ valence state are desirable. Examples of such vanadium (III) compounds include vanadyl naphthanate and vanadyl acetylacetonate. These vanadium (III) compounds should be used in an amount of 50 ppm to about 5,000 ppm, such as about 500 ppm to about 2,500 ppm, for instance about 1,000 ppm.

As regards cobalt compounds, cobalt compounds where cobalt enjoys a 2+ valence state are desirable. Examples of such cobalt (II) compounds include cobalt naphthenate, cobalt tetrafluoroborate and cobalt acetylacetonate. These cobalt (II) compounds should be used in an amount of about 100 ppm to about 1000 ppm.

As regards iron compounds, iron compounds where iron enjoys a 3+ valence state are desirable. Examples of such iron (III) compounds include iron acetate, iron acetylacetonate, iron tetrafluoroborate, iron perchlorate, and iron chloride. These iron compounds should be used in an amount of about 100 ppm to about 1000 ppm.

In at least one of the first part or the second part of the inventive two part composition, a core-shell impact modifier is included, which itself comprises a polymeric core and at least two polymeric layers surrounding the core, each layer having a different polymer composition from the other layer and, where at least one polymeric layer comprises a polymer that is a gradient polymer, the gradient polymer being a copolymer consisting of at least two different monomers (A) and (B) and having a gradient in repeat units arranged from mostly the monomer (A) to mostly the monomer (B) along the copolymer, and wherein when mixed together the peroxide catalyst initiates cure of the free radical curable component and the transition metal initiates cure of the cyanoacrylate component.

The core-shell impact modifier should comprise a particle having a particle size between 170 and 350 nm and a pH between 6 and 7.5 comprising one polymeric rubber core comprising at least partially crosslinked isoprene or butadiene and optionally styrene, and at least two polymeric layers wherein at least one polymeric layer is an outermost thermoplastic shell layer having a Tg greater than 25° C., each layer having a different polymer composition.

The core-shell impact modifier should comprise a polymeric rubber core is surrounded by a polymeric layer which is a polymeric core layer, the polymeric core layer having a glass transition temperature under 0° C. and a different polymer composition than the polymeric rubber core, where the polymeric core layer is a gradient zone.

The core-shell impact modifier should comprise at least one polymeric core layer and at least two polymeric shell layers, the polymeric core layer having a different composition than the polymeric shell layers, where each shell layer has a different polymer composition from the other shell layer, and where at least one polymeric shell layer is a gradient zone.

The core-shell impact modifier should comprise a polymeric rubber core with a glass transition temperature of less than 0° C., such as less than about −10° C., desirably less than about −20° C. and advantageously less than about −25° C. and most advantageously less than about −40° C., such as between about −80° C. and about −40° C.

The core-shell impact modifier should comprise a polymeric rubber core constructed from any one or more of isoprene homopolymers or butadiene homopolymers, isoprene-butadiene copolymers, copolymers of isoprene with at most 98 percent by weight of a vinyl monomer and copolymers of butadiene with at most 98 percent by weight of a vinyl monomer. The vinyl monomer may be styrene, an alkylstyrene, acrylonitrile, an alkyl (meth)acrylate, or butadiene or isoprene. Desirably, the core should be constructed of one of polybutadiene, a copolymer of butadiene and styrene or a terpolymer of methyl methacrylate, butadiene and styrene.

In some embodiments, the core may also be covered by a core layer. By core layer is meant that the polymer composition of that core layer has a glass transition temperature (Tg) of less than 0° C., such as less than about −10° C., desirably less than about −20° C., and advantageously less than about −25° C. Desirably, the core layer is a gradient polymer.

The core-shell impact modifier should have more than one shell and desirably two shells. At least the outer shell, in contact with the thermoplastic matrix, has a Tg greater than about 25° C., such as greater than about 50° C.

The shell(s) of the core-shell impact modifier may be constructed from one or more of: styrene homopolymers, alkylstyrene homopolymers or methyl methacrylate homopolymers, or copolymers comprising at least 70 wt % of one of the above monomers and at least one comonomer chosen from the other above monomers, another alkyl (meth)acrylate, vinyl acetate and acrylonitrile. The shell may be functionalized for instance with anhydrides of unsaturated carboxylic acids, unsaturated carboxylic acids and unsaturated epoxides, for instance maleic anhydride, (meth)acrylic acid glycidyl methacrylate, hydroxyethyl methacrylate and alkyl (meth)acrylamides.

The gradient copolymer is created by occupying a position between two layers, and in so doing creates a gradient zone in which at one side is richer in the monomer/polymer from the neighbouring layer and at the other side is richer in the different monomer/polymer that forms the next layer. The gradient zone between the core and a shell or between two polymer shells may be produced for example by monomers that have different copolymerization parameters or by carrying out the reaction in a semi-continuous mode under starved feed conditions where the rate of the addition of the monomers is slower than is the rate of the reaction. The gradient polymer is however never the outermost layer of the core shell particle.

The monomers used to form the gradient polymer are chosen on function of the neighbouring layers from the monomers cited with the core and the respective shells.

The young's modulus of the polymeric rubber core is always less than the modulus of the other polymeric layers. The young's modulus of the layer comprising the gradient polymer is always less than the modulus of the outer most layer.

The core-shell impact modifier should be in the form of fine particles having a rubber core and at least one thermoplastic shell, the particle size being generally less than 1 μm and advantageously between 50 nm and 500 nm, preferably between 100 nm and 400 nm, and most preferably 150 nm and 350 nm, advantageously between 170 nm and 350 nm.

The core-shell impact modifier may be prepared by emulsion polymerization. For example, a suitable method is a two-stage polymerization technique in which the core and shell are produced in two sequential emulsion polymerization stages. If there are more shells another emulsion polymerization stage follows. A graft copolymer is obtained by graft-polymerizing a monomer or monomer mixture containing at least an aromatic vinyl, alkyl methacrylate or alkyl acrylate in the presence of a latex containing a butadiene-based rubber polymer. See the '036 and the '314 patents for more detailed information regarding the method of manufacturing such core-shell impact modifiers. Commercially available examples of such core-shell impact modifiers ae available commercially under the CLEARSTRENGTH tradename from Arkema Inc., Cary, NC. Arkema describes CLEARSTRENGTH XT100, for instance, as a methyl methacrylate-butadiene-styrene core-shell toughening agent, which is compatible with various monomers and easily dispersible in most liquid resin systems, and exhibits a limited impact on their viscosity while providing a toughening effect over a wide range of service temperatures.

The core-shell impact modifier may be present in either or both of part A or part B. The core-shell impact modifier should be present in either or both of part A or part B in an amount of from about 2 percent by weight to about 20 percent by weight.

As discussed above, additives may be included in either or both of the part A or the part B compositions to influence a variety of performance properties.

Fillers contemplated for use include, for example, aluminum nitride, boron nitride, silicon carbide, diamond, graphite, beryllium oxide, magnesia, silicas, such as fumed silica or fused silica, alumina, perfluorinated hydrocarbon polymers (i.e., TEFLON), thermoplastic polymers, thermoplastic elastomers, mica, glass powder and the like. Preferably, the particle size of these fillers will be about 20 microns or less.

As regards silicas, the silica may have a mean particle diameter on the nanoparticle size; that is, having a mean particle diameter on the order of 10-9 meters. The silica nanoparticles can be pre-dispersed in epoxy resins and may be selected from those available under the tradename NANOPOCRYL, from Nanoresins, Germany. NANOCRYL is a tradename for a product family of silica nanoparticle reinforced (meth)acrylates. The silica phase consists of surface-modified, synthetic SiO₂ nanospheres with less than 50 nm diameter and an extremely narrow particle size distribution. The SiO₂ nanospheres are agglomerate-free dispersions in the (meth)acrylate matrix resulting in a low viscosity for resins containing up to 50 weight percent silica.

The silica component should be present in an amount in the range of about 1 to about 60 weight percent, such as about 3 to about 30 weight percent, desirably about 5 to about 20 weight percent, based on the total weight of the composition.

Thickeners are also useful.

Stabilizers and inhibitors may also be employed to control and prevent premature peroxide decomposition and polymerization. The inhibitors may be selected from hydroquinones, benzoquinones, naphthoquinones, phenanthroquinones, anthraquinones, and substituted compounds thereof. Various phenols may also be used as inhibitors, such as 2,6-di-tertiary-butyl-4-methyl phenol. The inhibitors may be used in quantities of about 0.1 percent to about 1.0 percent by weight of the total composition without adverse effect on the curing rate of the polymerizable adhesive composition.

In practice, each of the Part A and the Part B compositions are housed in separate containment vessels in a device prior to use, where in use the two parts are expressed from the vessels mixed and applied onto a substrate surface. The vessels may be chambers of a dual chambered cartridge, where the separate parts are advanced through the chambers with plungers through an orifice (which may be a common one or adjacent ones) and then through a mixing dispense nozzle. Or the vessels may be coaxial or side-by-side pouches, which may be cut or torn and the contents thereof mixed and applied onto a substrate surface.

The inventive composition when disposed between two substrates spaced apart by about 1 mm and cured to reaction products demonstrate a drop impact strength of greater than about 40 Joules.

The inventive composition when cured to reaction products demonstrate a greater drop impact strength on substrates bonded together in a 1 mm spaced apart relationship than on substrates bonded together in a 0 mm spaced apart relationship.

The invention will be more readily appreciated by a review of the examples, which follow.

### Examples

Reference to ECA means ethyl-2-cyanoacrylate.

With reference to Table 1, an adhesive system was prepared for control purposes where the Part A included ECA, mixed with LEVAPREN 900, t-BPB and a boron trifluoride/methane sulfonic acid combination, and the Part B included as the (meth)acrylate component the combination of an acrylated urethane ester, HPMA, and CN 2003 EU, to which was added a hydrated copper chlorate and a filler package as noted.

TABLE 1
Part A

| Components | | Sample/Amt (wt %) |
|---|---|---|
| Type | Identity | 1A |
| Cyanoacrylate | ECA | 68.9 |
| Toughener | LEVAPREN 900* | 22.5 |
| Peroxide | t-BPB | 5.0 |
| Stabilizer⁺ | BF₃/MSA | 3.6 |

Part B

| Components | | Sample/Amt (wt %) | | | | |
|---|---|---|---|---|---|---|
| Type | Identity | 1B | 2B | 3B | 4B | 5B |
| (Meth) acrylate | Acrylated | 33 | 33 | 33 | 33 | 33 |
| | Urethane Ester¹ | | | | | |
| | HPMA | 26 | 26 | 26 | 26 | 26 |
| | CN 2003 EU² | 18 | 18 | 18 | 18 | 18 |
| Transition Metal | Cu (ClO₄)₂•(H₂O) ₆ | 2.5 | 2.5 | 2.5 | 2.5 | 2.5 |
| | (20 wt % in HPMA) | | | | | |
| Filler | KAYAMER PM2³ | 0.02 | 0.02 | 0.02 | 0.02 | 0.02 |
| | HOMBINAN LW⁴ | 0.48 | 0.48 | 0.48 | 0.48 | 0.48 |
| Core Shell | XT-100⁵ | 20 | | | | |
| Rubber | B-Tough C2⁶ | | 20 | | | |
| | B-Tough 1A⁷ | | | 20 | | |
| | Kane Ace B564⁸ | | | | 20 | |
| | D-480⁹ | | | | | 20 |

*Ethylene/vinyl acetate copolymer, available commercially from Lanxess Ltd.
⁺As a stock solution
¹Made in sequential steps from the reaction of diols and dicarboxylic acids to form polyester diols, followed by reaction with toluene diisocyanate and finally capping with hydroxy propyl (meth) acrylate
²Epoxy acrylate, as reported by the manufacturer, Sartomer division of Arkema
³bis-(2-(Methacryloyloxy) ethyl) phosphate, which acts as an adhesion promoter
⁴pigment (white)
⁵CLEARSTRENGTH XT-100 is available commercially from Arkema Inc., which reports it as a methyl methacrylate-butadiene-styrene core-shell toughening agent
⁶Croda introduced an innovative technology B-Tough, to improve hardness without negatively impacting flexibility. According to Croda, epoxy toughening can be achieved by reaction-induced phase separation. The molecular weight and polarity of B-Tough C2r and C2x are designed to induce phase separation, while being compatible enough to react. The soft toughening segments are grafted in the hard epoxy matrix and will not migrate to the surface as is often the case with physically blended toughening agents. B-Tough C series is reported to offer improve flexibility while maintaining hardness, excellent impact strength also at lower temperatures, provide of ease formulation non-migration due to epoxy functionality.
⁷Croda offers commercially B-Tough A, a range of epoxy functionalized toughening agents. The rubbery particles are reported by Croda to be grafted in the hard epoxy matrix, securing an even distribution through the adhesive and preventing migration to the surface, as is often the case with physically blended toughening agents. B-Tough A series is reported to show excellent toughening performance for impact resistance, improve adhesion after humid ageing, protect substrates from moisture diffusion, and provide ease formulation. Soft B-Tough A particles are reported to be evenly distributed in a hard epoxy matrix, which improves the impact resistance of the system. Toughening of the hard epoxy matrix allows absorption of impact and thermal stress and reduces cracking caused by fatigue, thereby extending the lifetime of the adhesive system. The advantage of the B-Tough A series is that the polarity of the epoxy formulation can be matched with the different B-Tough A grades, optimizing the phase separated morphology. Optimal toughness is obtained with particles of about 2 to 6 μm size.
⁸Available commercially from Kaneka North America LLC, Kane Ace B-564 is reported to be a methylmethacrylate/butadiene/styrene copolymer modifier with high impact resistance designed for opaque applications. Kane Ace B-564 is a high impact-efficiency MBS modifier designed to enhance the impact properties of polyvinyl chloride (PVC) blow-molded containers, injection molded parts, and calendared sheet. Key attributes of Kane Ace B-564 are superior impact efficiency and a broad processing window.
⁹DURASTRENGTH 480 is reported by the manufacturer, Arkema, to be an acrylic core shell impact modifier designed to impart excellent impact properties and cold temperature toughness to engineering polymers, such as polycarbonate and its blends. DURASTRENGTH 480 impact modifier is also reported to offer outstanding long-term weather resistance making it ideal for outdoor applications. DURASTRENGTH 480 impact modifier has a high rubber content allowing excellent impact at ambient and cold temperatures and DURASTRENGTH 480 impact modifier provides exceptional impact retention needed for high temperature end-use applications.

The 1A-1B system was mixed and dispensed onto grit blasted mild steel lap shears in a 0 mm gap configuration and a 1 mm gap configuration with the noted substrates mated in an overlapped, off-set manner with the adhesive system disposed between the substrates in the overlapped, off-set portion. The substrates were of a thickness of 0.120±0.005 inches.

As above, the 1A-2B, 1A-3B, 1A-4B, and 1A-5B systems were mixed and dispensed onto grit blasted mild steel lap shears in a 0 mm gap configuration and a 1 mm gap configuration with the noted substrates mated in an overlapped, off-set manner with the adhesive system disposed between the substrates in the overlapped, off-set portion. The substrates were of a thickness of 0.120±0.005 inches.

In Table 2 below, the drop impact strength performance of these systems is recorded.

TABLE 2

| | | Drop Impact (J) | |
|---|---|---|---|
| Core Shell | Sample Name | 0 mm gap | 1 mm gap |
| XT-100 | 1A-1B | 14.1 | 44.6 |
| B-Tough C2 | 1A-2B | 5.1 | 8.8 |
| B-Tough A1 | 1A-3B | 5.1 | 5.2 |
| Kane Ace B564 | 1A-4B | 8.7 | 4.3 |
| D-480 | 1A-5B | 4.9 | 2.2 |

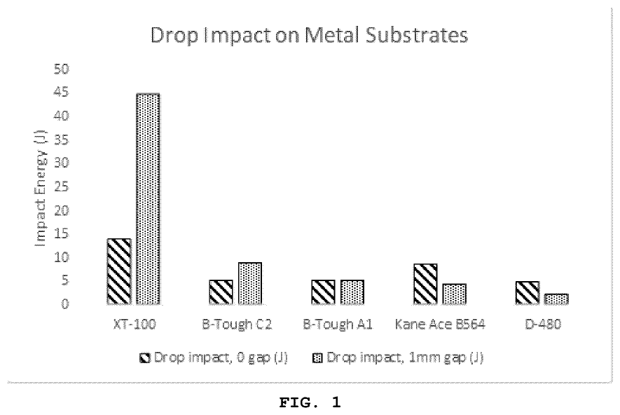

The 1A-1B system showed drop impact strength performance as recorded in Table 2 of 14.1 Joules at 0 mm gap and 44.6 Joules at 1 mm gap, based on an average of five replicates. This observation correlates to a greater than 3 times increase in strength when a gap of 1 mm is introduced between the bonded substrates. The remaining systems showed modest performance outright and only one other showed an improvement in a spaced apart configuration. (See FIG. 1.)

What is claimed is:

1. A two-part curable composition comprising:
(a) a first part comprising a cyanoacrylate component and a peroxide catalyst; and
(b) a second part comprising a free radical curable component and a transition metal, wherein at least one of the first part or the second part further comprises from 2 percent by weight to 20 percent by weight in the part of a core-shell impact modifier comprising a polymeric core and at least two polymeric layers surrounding the core,
wherein the core-shell impact modifier is a particle having a particle size between 170 and 350 nm and a pH between 6 and 7.5 comprising one polymeric rubber core comprising at least partially crosslinked isoprene or butadiene and optionally styrene, and at least two polymeric layers wherein at least one polymeric layer is an outermost thermoplastic shell layer having a Tg greater than 25° C., each layer having a different polymer composition and,
wherein at least one polymeric layer comprises a polymer that is a gradient polymer, the gradient polymer being a copolymer consisting of at least two different monomers (A) and (B) and having a gradient in repeat units arranged from mostly the monomer (A) to mostly the monomer (B) along the copolymer, and wherein when mixed together the peroxide catalyst initiates cure of the free radical curable component and the transition metal initiates cure of the cyanoacrylate component.

2. The composition of claim 1, wherein the cyanoacrylate component comprises H₂C═C(CN)—COOR, wherein R is selected from alkyl, alkoxyalkyl, cycloalkyl, alkenyl, aralkyl, aryl, allyl and haloalkyl groups.

3. The composition of claim 1, wherein the peroxide catalyst comprises perbenzoates.

4. The composition of claim 1, wherein the peroxide catalyst is t-butyl perbenzoate.

5. The composition of claim 1, wherein the core-shell impact modifier comprises a polymeric rubber core is surrounded by a polymeric layer which is a polymeric core layer, the polymeric core layer having a glass transition temperature under 0° C. and a different polymer composition than the polymeric rubber core, wherein said polymeric core layer is a gradient zone.

6. The composition of claim 1, wherein the core-shell impact modifier comprises at least one polymeric core layer and at least two polymeric shell layers, the polymeric core layer having a different composition than the polymeric core and the shell layers, wherein each shell layer has a different polymer composition from the other shell layer, and wherein at least one polymeric shell layer is a gradient zone.

7. The composition of claim 1, wherein the core-shell impact modifier comprises a polymeric rubber core with a glass transition temperature of less than −40° C.

8. The composition of claim 1, wherein the core-shell impact modifier comprises a polymeric rubber core with a glass transition temperature of between −80° C. and −40° C.

9. The composition of claim 1, wherein the core-shell impact modifier comprises a polymeric rubber core constructed from polybutadiene.

10. The composition of claim 1, wherein the core-shell impact modifier comprises a polymeric rubber core constructed from butadiene and styrene.

11. The composition of claim 1, wherein the core-shell impact modifier comprises a polymeric rubber core constructed from methyl methacrylate, butadiene and styrene.

12. The composition of claim 1, wherein the core-shell impact modifier is present in the first part.

13. The composition of claim 1, wherein the core-shell impact modifier is present in the second part.

14. The composition of claim 1, wherein the peroxide catalyst is present in an amount from 0.01 percent to 10 percent by weight, based on the cyanoacrylate component.

15. The composition of claim 1, wherein the free radical curable component is a (meth)acrylate component selected from the group consisting of polyethylene glycol di(meth)acrylates, tetrahydrofuran (meth)acrylates and di(meth)acrylates, hydroxypropyl (meth)acrylate, hexanediol di(meth)acrylate, trimethylol propane tri(meth)acrylate, diethylene glycol dimethacrylate, triethylene glycol dimethacrylate, benzylmethacrylate, tetraethylene glycol dimethacrylate, dipropylene glycol dimethacrylate, di-(pentamethylene glycol) dimethacrylate, tetraethylene diglycol diacrylate, diglycerol tetramethacrylate, tetramethylene dimethacrylate, ethylene dimethacrylate, neopentyl glycol diacrylate, trimethylol propane triacrylate, ethoxylated bisphenol-A (meth)acrylate, ethoxylated bisphenol-F (meth)acrylate, and methacrylate-functional urethanes.

16. The composition of claim 1, wherein the transition metal comprises a member selected from the group consisting of copper, vanadium, cobalt and iron.

17. The composition of claim 1, wherein the first part is housed in a first chamber of a dual chamber syringe and the second part is housed in a second chamber of the dual chamber syringe.

18. The composition of claim 1, wherein the second part further comprises at least one of a plasticizer and a filler.
